(19) United States
(12) Patent Application Publication
(10) Pub. No.: US 2006/0146225 A1
(43) Pub. Date: Jul. 6, 2006

(54) Liquid crystal display apparatus

(75) Inventor: Cheol-Jin Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/315,274

(22) Filed: Dec. 23, 2005

(30) Foreign Application Priority Data
Jan. 5, 2005 (KR) 2005-0000773

(51) Int. Cl. G02F 1/1333

(52) U.S. Cl. 349/58

(57) ABSTRACT

The present invention relates to a liquid crystal display (LCD) apparatus, comprising a top chassis; a display panel provided in rear of the top chassis; a lamp provided in rear of the top chassis driven by parallel electrode power; and a bottom chassis provided in rear of the lamp formed with current leakage preventing holes to reduce the leakage current from the lamp as much as possible. Thus, the present invention provides a liquid crystal display apparatus capable of reducing leakage current generated between a lamp and a bottom chassis as much as possible.

### CROSS-REFERENCE TO RELATED APPLICATIONS

This application claims the benefit under 35 U.S.C. §119(a) of Korean Patent Application No. 2005-0000773, filed on Jan. 5, 2005, in the Korean Intellectual Property Office, the entire disclosure of which is hereby incorporated by reference.

### BACKGROUND OF INVENTION

1. Field of Invention:

The present invention relates to a liquid crystal display apparatus. More particularly, the present invention relates to a liquid crystal display apparatus capable of reducing leakage current generated between a lamp and a bottom chassis.

2. Description of the Related Art:

Recently, application of liquid crystal displays (LCD) which are a kind of flat panel display have gradually been extended to a monitor, a TV set, and the like, and demands thereon has been increased accordingly.

Referring to FIG. 1, a conventional liquid crystal display apparatus comprises a top chassis, a display panel provided behind the top chassis, a lamp 2 provided in the rear of the display panel, and a bottom chassis 4 provided behind the lamp coupled with the top chassis. As illustrated in FIG. 1, the lamp 2 is supported within the bottom chassis 4.

However, the liquid crystal display apparatus with the above-described construction causes leakage current generated between the lamp 2 and the bottom chassis 4, when external power is supplied through an electrode part 3 of the lamp 2. The current leakage is particularly heavy around the electrode part 3 of the lamp 2. Because of the current leakage, when power is supplied after the lamp 2 has been left at low temperature, at least one partial dark area is generated and fluctuations in consumption power are also heavy.

In addition, this may result in widening current deviations between the left and the right sides of the lamp 2 and also increasing the temperature of the backlight unit.

Accordingly, a need exists for a liquid crystal display apparatus capable of reducing current leakage between a lamp and a bottom chassis.

### SUMMARY OF THE INVENTION

Accordingly, An aspect of the present invention to provide a liquid crystal display apparatus capable of reducing leakage current generated between a lamp and a bottom chassis as minimum as possible is provided.

Additional aspects and/or advantages of the invention will be described below. The foregoing and other aspects of the present invention are achieved by providing a liquid crystal display (LCD) apparatus, comprising a top chassis; a display panel provided in rear of the top chassis; a lamp provided behind the top chassis, which is driven by parallel electrode power; and a bottom chassis provided behind the lamp, which is formed with current leakage preventing holes to reduce the leakage current from the lamp.

According to another aspect of the present invention, the current leakage preventing holes are partially positioned on both sides of the bottom chassis, corresponding to electrode parts of the lamp.

According to another aspect of the present invention, the lamp is a flat fluorescent lamp (FFL).

According to another aspect of the present invention, the lamp is an external electrode fluorescent lamp (EEFL).

Other objects, advantages and salient features of the present invention will become apparent from the following detailed description of the embodiments, which, taken in conjunction with the annexed drawings, discloses exemplary embodiments of the invention.

### BRIEF DESCRIPTION OF THE DRAWINGS

FIG. 1 is a cross-sectional view illustrating a coupling structure of a lamp and a bottom chassis of a conventional liquid crystal display apparatus;

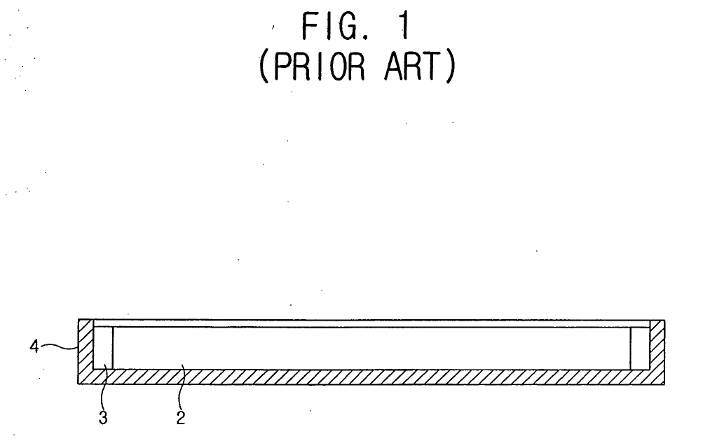

FIG. 2 is an exploded perspective view of a liquid crystal display apparatus according to an embodiment of the present invention;

FIG. 3 is a rear view of a liquid crystal display apparatus according to an embodiment of the present invention; and

FIG. 4 is a cross-sectional view illustrating a coupling structure of a lamp and a bottom chassis of a liquid crystal display apparatus according to an embodiment of the present invention.

Throughout the drawings, like reference numerals will be understood to refer to like parts, components and structures.

### DETAILED DESCRIPTION OF EXAMPLARY EMBODIMENTS

Exemplary embodiments of the present invention are illustrated and described by referring to the figures in the accompanying drawings.

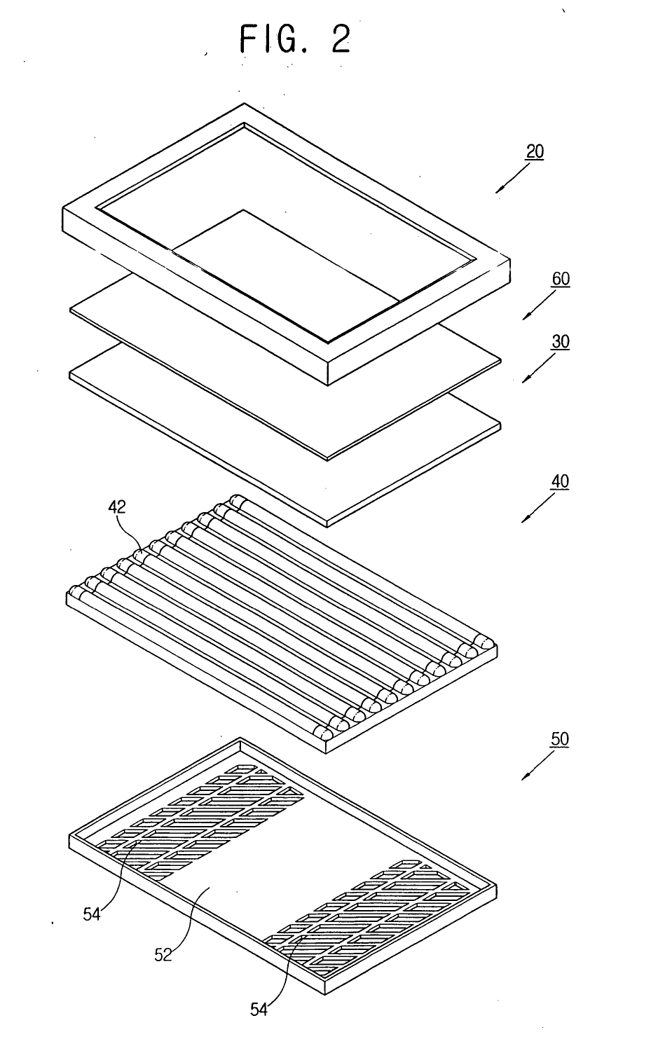

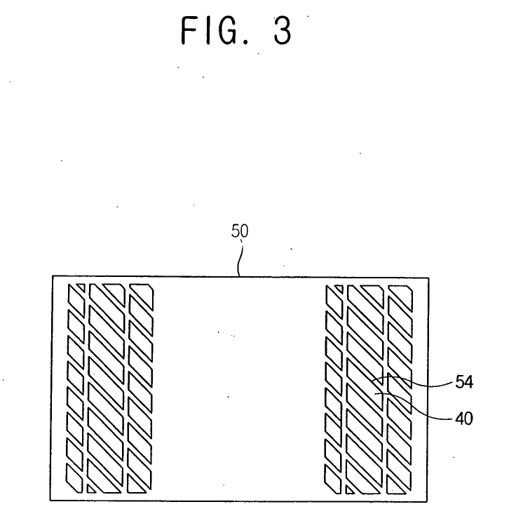

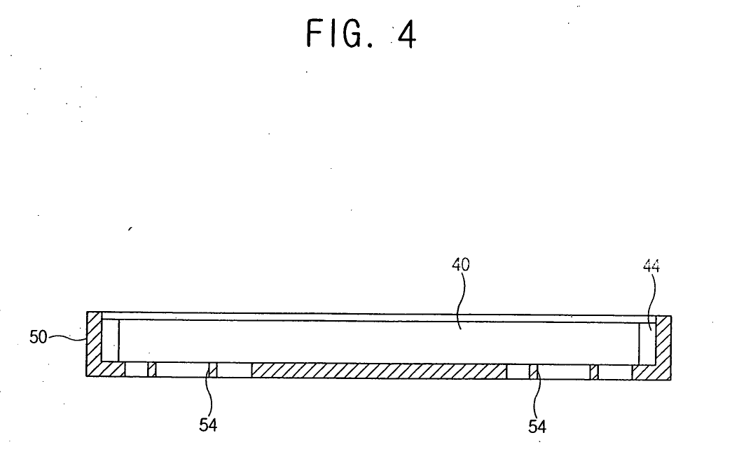

As illustrated in FIGS. 2 through 4, a liquid crystal display apparatus according to an embodiment of the present invention comprises a top chassis 20, a display panel 30 provided behind the top chassis 20, a lamp 40 provided behind of the display panel 30, which is driven by parallel electrode power, and a bottom chassis 50 provided behind the lamp 40, which is coupled with the top chassis 20.

The top chassis 20 has a frame structure having a rectangular window in its center, and surrounding areas of the top chassis 20 bend at right angles, thereby forming lateral walls.

The display panel 30 supplies voltages to a liquid crystal provided between a pair of substrates, and changes molecular alignments, to thereby control lights supplied from the lamp 40, and as a result, a picture is formed on the display panel 30.

The lamp 40 employs a flat fluorescent lamp (FFL), a single fluorescent lamp shaped with a flat plate. On both sides of the lamp 40, the lamp comprises electrode parts 42 so that an electric field is applied to the lamps. The lamp 40 may employ external electrode fluorescent lamps (EEFL).

Considering functionality and economical efficiency, the lamp 40 is preferably driven in parallel by using only one inverter.

The bottom chassis 50 has a lamp receiving part 52 for receiving the lamp 40 therein, and the lamp receiving part 52 of the bottom chassis 50 is formed with a plurality of current leakage preventing holes 54 so as to reduce the leakage current from the lamp 40.

The current leakage preventing holes may be positioned in various manners. However, positioning of the holes on both sides of the bottom chassis is preferred, corresponding to both sides of electrode parts 42 of the lamp 40.

Shapes and sizes of the current leakage preventing holes 54 may be appropriately adjusted to the extent that the leakage current can be minimized.

An optical sheet 60 is provided to make brightness uniform by increasing an efficiency of collecting lights supplied from the lamp 40 and incident upon the display panel 30. The optical sheet 60 generally comprises a diffusion sheet (not shown) for diffusing light supplied from the lamp 40 to make it relatively uniform, and a prism sheet (not shown) for transforming a traveling passage of the lights diffused by the diffusion sheet at a predetermined angle.

Hereinafter, a method of minimizing the leakage current by preparing the current leakage preventing holes 54 will be described as below.

Generally, if a high voltage is supplied to the lamp 40 in a state that the bottom chassis 50 is connected to the ground, air between the bottom chassis 50 and the lamp 40 act as an insulator, thereby forming a condenser. Here, the bottom chassis 50 and the lamp 40 act as electrodes. As the results, the current leaks due to an electric capacity C of the condenser, and thus a lighting efficiency of the lamp 40 is decreased.

Whereas, according to the principle of the current leakage prevention of the present invention, the electric capacity C of the condenser decreases by preparing the current leakage preventing holes 54 on the both lateral sides of the bottom chassis 50. And thus, the leakage current minimizes dues to decreasing the electric capacity C.

Generally, if the condenser having the electric capacity C receives a voltage V, an electric charge Q=CV is accumulated therein. Here, the electric capacity C is in proportion to size of the electrodes, and is in inverse proportion to distance between the electrodes.

Specifically, in the prevent invention on the basis of the above general principle, the bottom chassis 50 comprises the current leakage preventing holes 54, thereby reducing the size of the electrodes and the electric capacity C decreases. As a result, the leakage current is reduced as the amount of the decreased electric capacity.

The liquid crystal display apparatus according to exemplary embodiments of the present invention is designed to minimize the leakage current generated between a lamp and a bottom chassis by changing a structure of the bottom chassis. Accordingly, the other structures except for it can be identical to those of conventional liquid crystal display apparatuses, and thus, detailed description thereof will be omitted.

As described above, according to exemplary embodiments of the present invention, the leakage current generated between a lamp and a bottom chassis may be minimized, thereby enhancing an efficiency of lighting the lamp.

While the present invention have been shown and described with reference to exemplary embodiments thereof, it will be appreciated by those skilled in the art that changes in form and details may be made therein without departing from the principles, spirit and scope of the invention, as defined by the appended claims and their equivalents.

What is claimed is:

1. A liquid crystal display (LCD) apparatus, comprising:
a top chassis;
a display panel provided behind the top chassis;
a lamp provided behind the top chassis driven by parallel electrode power; and
a bottom chassis provided behind the lamp comprising current leakage preventing holes adopted to reduce the leakage current from the lamp as much as possible.

2. The LCD apparatus of claim 1, wherein the current leakage preventing holes are partially formed on both sides of the bottom chassis, corresponding to electrode parts of the lamp.

3. The LCD apparatus of claim 1, wherein the lamp is a flat fluorescent lamp (FFL).

4. The LCD apparatus of claim 1, wherein the lamp is an external electrode fluorescent lamp (EEFL).
